(19) United States
(12) Patent Application Publication
(10) Pub. No.: US 2025/0059911 A1
(43) Pub. Date: Feb. 20, 2025

(54) TURBINE ENGINE INCLUDING A STEAM SYSTEM

(71) Applicant: General Electric Company, Schenectady, NY (US)

(72) Inventors: Arthur W. Sibbach, Boxford, MA (US); James R. Reepmeyer, Montgomery, OH (US); Erich Alois Krammer, West Chester, OH (US); Koji Asari, Sharonville, OH (US); Robert R. Rachedi, Morrow, OH (US)

(21) Appl. No.: 18/451,429

(22) Filed: Aug. 17, 2023

(51) Int. Cl. F02C 6/00; F01K 11/02; F01K 15/02

(52) U.S. Cl. CPC F02C 3/30; F02C 3/305; F02C 6/18

(57) ABSTRACT

A turbine engine for an aircraft. The turbine engine includes a combustor, a core shaft, a turbine, and a steam system providing steam to a core air flow path. The steam system includes a boiler that receives combustion gases to boil water to generate steam. A steam turbine is fluidly coupled to the boiler to receive the steam from the boiler and to cause the steam turbine to rotate. The steam turbine is coupled to the core shaft to rotate the core shaft when the steam turbine rotates. The steam system may include a bypass flow path selectively operable to redirect at least one of the steam or water, and to bypass the core air flow path. The turbine engine may also include at least one steam control valve located downstream of the boiler and upstream of the core air flow path to control the flow of steam.

### TECHNICAL FIELD

The present disclosure relates generally to turbine engines including a steam system.

### BACKGROUND

Turbine engines used in aircraft generally include a fan and a core section arranged in flow communication with one another. A combustor is arranged in the core section to generate combustion gases for driving a turbine in the core section of the turbine engine.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic cross-sectional diagram of a turbine engine including a steam system, taken along a longitudinal centerline axis of the turbine engine, according to the present disclosure.

FIG. 2 is a schematic diagram of the turbine engine and a steam system according to an embodiment of the present disclosure.

FIG. 3 is a schematic diagram of the turbine engine and a steam system according to an embodiment of the present disclosure.

FIG. 4 is a schematic diagram of the turbine engine and a steam system according to an embodiment of the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or a vehicle, and refer to the normal operational attitude of the turbine engine or the vehicle. For example, with regard to a turbine engine, forward refers to a position closer to an engine inlet and aft refers to a position closer to an engine nozzle or an exhaust.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, a “bypass ratio” of a turbine engine is a ratio of bypass air through a bypass of the turbine engine to core air through a core inlet of a core turbine engine of the turbine engine. For example, the bypass ratio is a ratio of bypass air 62 entering the bypass airflow passage 56 to core air 64 entering the core turbine engine 16.

As used herein, a “compression ratio” of a compressor is a ratio of a compressor exit pressure at an exit of the compressor to a compressor inlet pressure at an inlet of the compressor. The compressor exit pressure and the compressor inlet pressure are measured as static air pressures perpendicular to the direction of the core air flow through the compressor.

As used herein, a “pressure expansion ratio” of a turbine is a ratio of a pressure at an inlet of the turbine to a pressure at an exit of the turbine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

As noted above, a combustor is arranged in the core section to generate combustion gases for driving a turbine in the core section of the turbine engine. Not all of the energy and heat generated by the combustor is used to drive the turbine(s) of the turbine section. Instead, some of the waste heat is exhausted through a jet exhaust nozzle section in a conventional turbine engine. The turbine engine discussed herein includes a steam system that is used to recover some of the energy from the waste heat by generating steam and driving a steam turbine. After flowing through the steam turbine, the steam may be injected into the combustor. The steam may be used for various different purposes within the combustor, including as a diluent and as a cooling fluid for various components and to add mass flow to the core air, such that less core air is needed to produce the same amount of work through the turbine section. Using steam in the combustor may not be desirable in all operational conditions, however, and thus the embodiments discussed herein discloses various features and system configurations that allow the amount of steam injected into the combustor to be controlled and, in some cases, bypassed.

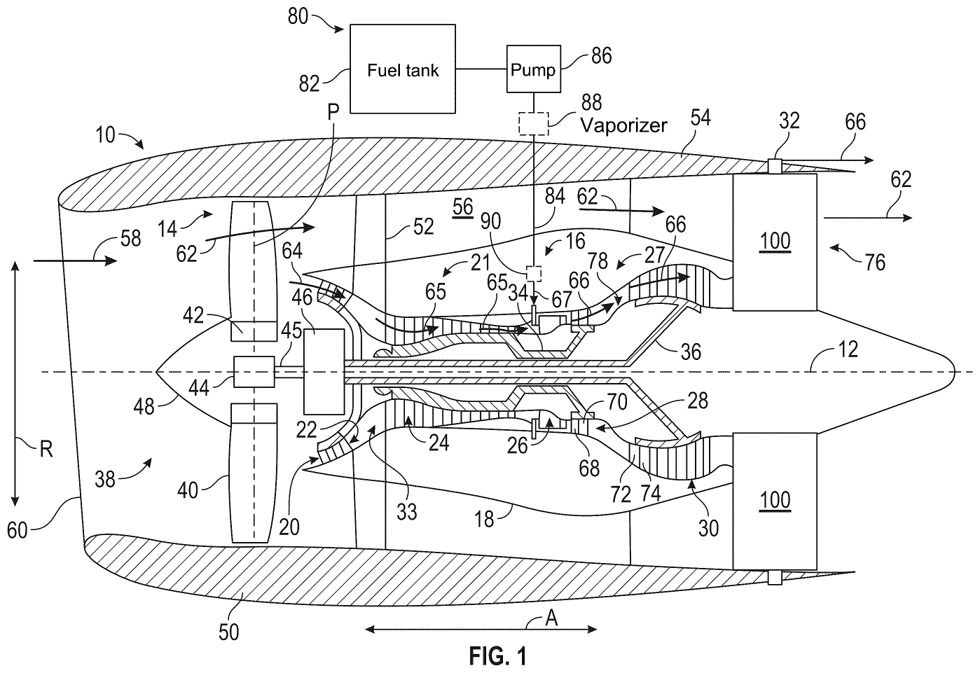

Referring now to the drawings, FIG. 1 is a schematic cross-sectional diagram of a turbine engine 10 including a steam system 100, taken along a longitudinal centerline axis 12 (provided for reference) of the turbine engine 10, according to an embodiment of the present disclosure. As shown in FIG. 1, the turbine engine 10 has an axial direction A (extending parallel to the longitudinal centerline axis 12) and a radial direction R that is normal to the axial direction A. In general, the turbine engine 10 includes a fan section 14 and a core turbine engine 16 disposed downstream from the fan section 14.

The core turbine engine 16 includes an outer casing 18 that is substantially tubular and defines an annular core inlet 20. As schematically shown in FIG. 1, the outer casing 18 encases, in serial flow relationship, a compressor section 21 including a booster or a low-pressure compressor (LPC) 22 followed downstream by a high-pressure compressor (HPC) 24, a combustor 26, a turbine section 27, including a high-pressure turbine (HPT) 28, followed downstream by a low-pressure turbine (LPT) 30, and one or more core exhaust nozzles 32. A high-pressure (HP) shaft 34 or a spool drivingly connects the HPT 28 to the HPC 24 to rotate the HPT 28 and the HPC 24 in unison. The HPT 28 is drivingly coupled to the HP shaft 34 to rotate the HP shaft 34 when the HPT 28 rotates. A low-pressure (LP) shaft 36 drivingly connects the LPT 30 to the LPC 22 to rotate the LPT 30 and the LPC 22 in unison. The LPT 30 is drivingly coupled to the LP shaft 36 to rotate the LP shaft 36 when the LPT 30 rotates. The compressor section 21, the combustor 26, the turbine section 27, and the one or more core exhaust nozzles 32 together define a core air flow path 33.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the core turbine engine 16. The nacelle 50 is supported relative to the core turbine engine 16 by a plurality of circumferentially spaced outlet guide vanes 52. Moreover, a downstream section 54 of the nacelle 50 extends over an outer portion of the core turbine engine 16 to define a bypass airflow passage 56 therebetween. The one or more core exhaust nozzles 32 may extend through the nacelle 50 and be formed therein. In this embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

During operation of the turbine engine 10, a volume of air 58 enters the turbine engine 10 through an inlet 60 of the nacelle 50 and/or the fan section 14. As the volume of air 58 passes across the fan blades 40, a first portion of air (bypass air 62) is directed or routed into the bypass airflow passage 56, and a second portion of air (core air 64) is directed or is routed into the upstream section of the core air flow path 33, or, more specifically, into the core inlet 20. The ratio between the first portion of air (bypass air 62) and the second portion of air (core air 64) is known as a bypass ratio. In some embodiments, the bypass ratio is greater than 18:1, enabled by the steam system 100, detailed further below. The pressure of the core air 64 is then increased by the LPC 22, generating compressed air 65, and the compressed air 65 is routed through the HPC 24 and further compressed before being directed into the combustor 26, where the compressed air 65 is mixed with fuel 67 and burned to generate combustion gases 66 (combustion products). One or more stages may be used in each of the LPC 22 and the HPC 24, with each subsequent stage further compressing the compressed air 65. The HPC 24 has a compression ratio greater than 20:1, preferably, in a range of 20:1 to 40:1. The compression ratio is a ratio of a pressure of a last stage of the HPC 24 to a pressure of a first stage of the HPC 24. The compression ratio greater than 20:1 is enabled by the steam system 100, as detailed further below.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, thereby supporting operation of the HPC 24. The combustion gases 66 are then routed into the LPT 30 and expanded through the LPT 30. Here, a second portion of thermal energy and/or the kinetic energy is extracted from the combustion gases 66 via sequential stages of LPT stator vanes 72 that are coupled to the outer casing 18 and LPT rotor blades 74 that are coupled to the LP shaft 36, thus, causing the LP shaft 36 to rotate, thereby supporting operation of the LPC 22 and rotation of the fan 38 via the gearbox assembly 46. One or more stages may be used in each of the HPT 28 and the LPT 30. The HPC 24 having a compression ratio in a range of 20:1 to 40:1 results in the HPT 28 having a pressure expansion ratio in a range of 1.5:1 to 4:1 and the LPT 30 having a pressure expansion ratio in a range of 4.5:1 to 28:1.

The combustion gases 66, after being routed through the steam system 100 (as discussed below), are subsequently routed through the one or more core exhaust nozzles 32 of the core turbine engine 16 to provide propulsive thrust. Simultaneously with the flow of the core air 64 through the core air flow path 33, the bypass air 62 is routed through the bypass airflow passage 56 before being exhausted from a fan bypass nozzle 76 of the turbine engine 10, also providing propulsive thrust. The HPT 28, the LPT 30, and the one or more core exhaust nozzles 32 at least partially define a hot gas path 78 for routing the combustion gases 66 through the core turbine engine 16.

As noted above, the compressed air 65 (the core air 64) is mixed with the fuel 67 in the combustor 26 to generate a fuel and air mixture, and combusted, generating combustion gases 66 (combustion products). The fuel 67 can include any type of fuel used for turbine engines, such as, for example, sustainable aviation fuels (SAF) including biofuels, JetA, or other hydrocarbon fuels. The fuel 67 also may be a hydrogen-based fuel (H₂), and, while hydrogen-based fuel may include blends with hydrocarbon fuels, the fuel 67 used herein is preferably unblended, and referred to herein as hydrogen fuel. In some embodiments, the hydrogen fuel may comprise substantially pure hydrogen molecules (i.e., diatomic hydrogen). The fuel 67 may also be a cryogenic fuel. For example, when the hydrogen fuel is used the hydrogen fuel may be stored in a liquid phase at cryogenic temperatures.

The turbine engine 10 includes a fuel system 80 for providing the fuel 67 to the combustor 26. The fuel system 80 includes a fuel tank 82 for storing the fuel 67 therein, and a fuel delivery assembly 84. The fuel tank 82 can be located on an aircraft (not shown) to which the turbine engine 10 is attached. While a single fuel tank 82 is shown in FIG. 1, the fuel system 80 can include any number of fuel tanks 82, as desired. The fuel delivery assembly 84 delivers the fuel 67 from the fuel tank 82 to the combustor 26. The fuel delivery assembly 84 includes one or more lines, conduits, pipes, tubes, etc., configured to carry the fuel 67 from the fuel tank 82 to the combustor 26. The fuel delivery assembly 84 also includes a pump 86 to induce the flow of the fuel 67 through the fuel delivery assembly 84 to the combustor 26. In this way, the pump 86 pumps the fuel 67 from the fuel tank 82, through the fuel delivery assembly 84, and into the combustor 26. The fuel system 80 and, more specifically, the fuel tank 82 and the fuel delivery assembly 84, either collectively or individually, may be a fuel source for the combustor 26.

In some embodiments, for example, when the fuel 67 is a hydrogen fuel, the fuel system 80 includes one or more vaporizers 88 (illustrated by dashed lines) and a metering valve 90 (illustrated by dashed lines) in fluid communication with the fuel delivery assembly 84. In this example, the hydrogen fuel is stored in the fuel tank 82 as liquid hydrogen fuel. The one or more vaporizers 88 heat the liquid hydrogen fuel flowing through the fuel delivery assembly 84. The one or more vaporizers 88 are positioned in the flow path of the fuel 67 between the fuel tank 82 and the combustor 26, and are located downstream of the pump 86. The one or more vaporizers 88 are in thermal communication with at least one heat source, such as, for example, waste heat from the turbine engine 10 and/or from one or more systems of the aircraft (not shown). The one or more vaporizers 88 heat the liquid hydrogen fuel and the liquid hydrogen fuel is converted into a gaseous hydrogen fuel within the one or more vaporizers 88. The fuel delivery assembly 84 directs the gaseous hydrogen fuel into the combustor 26.

The metering valve 90 is positioned downstream of the one or move vaporizers 88 and the pump 86. The metering valve 90 receives hydrogen fuel in a substantially completely gaseous phase, or in a substantially completely supercritical phase. The metering valve 90 provides the flow of fuel to the combustor 26 in a desired manner. More specifically, the metering valve 90 provides a desired volume of hydrogen fuel at, for example, a desired flow rate, to a fuel manifold that includes one or more fuel injectors that inject the hydrogen fuel into the combustor 26. The fuel system 80 can include any components for supplying the fuel 67 from the fuel tank 82 to the combustor 26, as desired.

The turbine engine 10 includes the steam system 100 in fluid communication with the one or more core exhaust nozzles 32 and the fan bypass nozzle 76. The steam system 100 extracts steam from the combustion gases 66 as the combustion gases 66 flow through the steam system 100, as detailed further below.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, and/or turboprop engines.

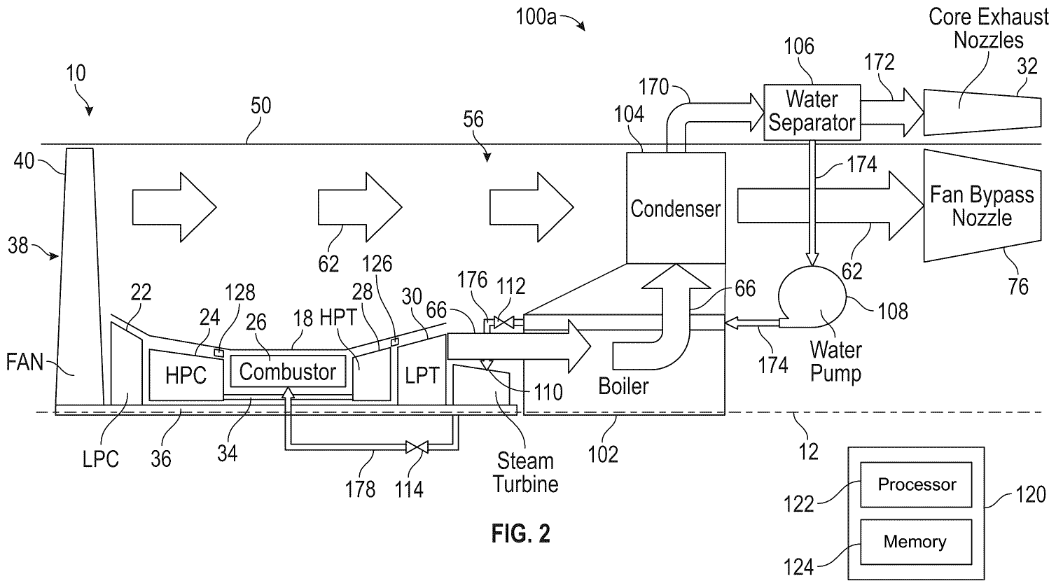

FIG. 2 is a schematic diagram of the turbine engine 10 having a steam system 100a, according to an embodiment of the present disclosure. For clarity with the other steam systems discussed herein, the steam system 100a of this embodiment will be referred to as a first steam system 100a. The first steam system 100a may be used as the steam system 100 in the turbine engine 10 shown in FIG. 1. For clarity, various features of the turbine engine 10 described and shown above are shown schematically in FIG. 2 and some components are not shown in FIG. 2, but the description of such components also applies here. The first steam system 100a includes a boiler 102, a condenser 104, a water separator 106, a water pump 108, and a steam turbine 110.

The boiler 102 is a heat exchanger that vaporizes liquid water from a water source to generate steam or water vapor, as detailed further below. The boiler 102 is thus a steam source. In particular, the boiler 102 is an exhaust gas-water heat exchanger. The boiler 102 is in fluid communication with the hot gas path 78 (FIG. 1) and is positioned downstream of the LPT 30. The boiler 102 is also in fluid communication with the water pump 108, as detailed further below. The boiler 102 can include any type of boiler or heat exchanger for extracting heat from the combustion gases 66 and vaporizing liquid water into steam or water vapor as the liquid water and the combustion gases 66 flow through the boiler 102.

The condenser 104 is a heat exchanger that further cools the combustion gases 66 as the combustion gases 66 flow through the condenser 104, as detailed further below. In particular, the condenser 104 is an air-exhaust gas heat exchanger. The condenser 104 is in fluid communication with the boiler 102 and, in this embodiment, is positioned within the bypass airflow passage 56. The condenser 104, however, may be positioned elsewhere and thermally connected to other cooling sources, such as being thermally connected to the fuel 67 to transfer heat to the fuel 67, particularly, when the fuel 67 is a cryogenic fuel such as hydrogen fuel. The condenser 104 can include any type of condenser for condensing water from the exhaust (e.g., the combustion gases 66).

The water separator 106 is in fluid communication with the condenser 104 for receiving cooled exhaust (combustion gases 66) having condensed water entrained therein. The water separator 106 is also in fluid communication with the one or more core exhaust nozzles 32 and with the water pump 108. The water separator 106 includes any type of water separator for separating water from the exhaust. For example, the water separator 106 can include a cyclonic separator that uses vortex separation to separate the water from the air. In such embodiments, the water separator 106 generates a cyclonic flow within the water separator 106 to separate the water from the cooled exhaust. In FIG. 2, the water separator 106 is schematically depicted as being in the nacelle 50, but the water separator 106 could be located at other locations within the turbine engine 10, such as, for example, radially inward of the nacelle 50, closer to the core turbine engine 16. The water separator 106 may be driven to rotate by one of the core shafts, such as the HP shaft 34 or the LP shaft 36. As noted above, the boiler 102 receives liquid water from a water source to generate steam or water vapor. In the embodiment depicted in FIG. 2, the condenser 104 and the water separator 106, individually or collectively, are the water source for the boiler 102.

The water pump 108 is in fluid communication with the water separator 106 and with the boiler 102. The water pump 108 is in fluid communication with the condenser 104 via the water separator 106. The water pump 108 may be any suitable pump, such as a centrifugal pump or a positive displacement pump. The water pump 108 directs the separated liquid water through the boiler 102 where it is converted back to steam. This steam is sent through the steam turbine 110 then injected into core air flow path 33, such as into the combustor 26.

In operation, the combustion gases 66, also referred to as exhaust, flow from the LPT 30 into the boiler 102. The combustion gases 66 transfer heat into the water 174 (e.g., in liquid form) within the boiler 102, as detailed further below. The combustion gases 66 then flow into the condenser 104. The condenser 104 condenses the water 174 (e.g., in liquid form) from the combustion gases 66. The bypass air 62 flows through the bypass airflow passage 56 and over or through the condenser 104 and extracts heat from the combustion gases 66, cooling the combustion gases 66 and condensing the water 174 from the combustion gases 66, to generate an exhaust-water mixture 170. The bypass air 62 is then exhausted out of the turbine engine 10 through the fan bypass nozzle 76 to generate thrust, as detailed above. The condenser 104 thus may be positioned in bypass airflow passage 56.

The exhaust-water mixture 170 flows into the water separator 106. The water separator 106 separates the water 174 from the exhaust of the exhaust-water mixture 170 to generate separate exhaust 172 and the water 174. The exhaust 172 is exhausted out of the turbine engine 10 through the one or more core exhaust nozzles 32 to generate thrust, as detailed above. The boiler 102, the condenser 104, and the water separator 106 thus also define a portion of the hot gas path 78 (see FIG. 1) for routing the combustion gases 66, the exhaust-water mixture 170, and the exhaust 172 through the steam system 100 of the turbine engine 10.

The water pump 108 pumps the water 174 (e.g., in liquid form) through one or more water lines (as indicated by the arrow for the water 174 in FIG. 2) and the water 174 flows through the boiler 102. As the water 174 flows through the boiler 102, the combustion gases 66 flowing through the boiler 102 transfer heat into the water 174 to vaporize the water 174 and to generate the steam 176 (e.g., vapor). The steam turbine 110 includes one or more stages of steam turbine blades (not shown) and steam turbine stators (not shown). The steam 176 flows from the boiler 102 into the steam turbine 110, through one or more steam lines (as indicated by the arrow for the steam 176 in FIG. 2), causing the steam turbine blades of the steam turbine 110 to rotate, thereby generating additional work in an output shaft (e.g., one of the core shafts) connected to the turbine blades of the steam turbine 110.

As noted above, the core turbine engine 16 includes shafts, also referred to as core shafts, coupling various rotating components of the core turbine engine 16 and other thrust producing components such as the fan 38. In the core turbine engine 16 shown in FIG. 1, these core shafts include the HP shaft 34 and the LP shaft 36. The steam turbine 110 is coupled to one of the core shafts of the core turbine engine 16, such as the HP shaft 34 or the LP shaft 36. In the illustrated embodiment, the steam turbine 110 is coupled to the LP shaft 36. As the steam 176 flows from the boiler 102 through the steam turbine 110, the kinetic energy of this gas is converted by the steam turbine 110 into mechanical work in the LP shaft 36. The reduced temperature steam (as steam 178) exiting the steam turbine 110 is then injected into the core air flow path 33, such as into the combustor 26, upstream of the combustor 26, or downstream of the combustor 26. The steam 178 flows through one or more steam lines from the steam turbine 110 to the core air flow path 33. The steam 178 injected into the core air flow path 33 adds mass flow to the core air 64 such that less core air 64 is needed to produce the same amount of work through the turbine section 27. In this way, the steam system 100 extracts additional work from the heat in exhaust gas that would otherwise be wasted. The steam 178 injected into the core air flow path 33 is in a range of 20% to 50% of the mass flow through the core air flow path 33.

The steam turbine 110 may have a pressure expansion ratio in a range of 2:1 to 6:1. The pressure expansion ratio is a ratio of the pressure at an inlet of the steam turbine 110 to the pressure at an exit of the steam turbine 110. The steam turbine 110 may contribute approximately 25% of the power to the LP shaft 36 (or to the HP shaft 34) when the steam system 100 recovers approximately 70% of the water 174 and converts the water 174 into the steam 176. The steam turbine 110 has a pressure expansion ratio in a range of 2:1 to 6:1, the LPT 30 has a pressure expansion ratio in a range of 4.5:1 to 28:1, and the steam 178 contributes to 20% to 50% of the mass flow through the core air flow path 33. The steam turbine 110 expands the steam 176, thereby reducing the energy of the steam 178 exiting the steam turbine 110 and reducing the temperature of the steam 178 to approximately a temperature of the compressed air 65 (see FIG. 1) that is discharged from the HPC 24. Such a configuration enables the steam 178 to reduce hot spots in the combustor 26 from the combustion of the fuel (e.g., in particular when the fuel is supercritical hydrogen or gaseous hydrogen).

The steam 178 injected into the core air flow path 33 also enables the HPT 28 to have a greater energy output with fewer stages of the HPT 28 as compared to HPTs without the benefit of the present disclosure. For example, the additional mass flow from the steam 178 through the turbine section 27 helps to produce a greater energy output. In this way, HPT 28 may only have one stage capable sustainably driving a higher number of stages of the HPC 24 (e.g., 10, 11, or 12 stages of the HPC 24) due to the higher mass flow (resulting from the steam injection) exiting the combustor 26. The steam 178 that is injected into the core air flow path 33 enables the HPT 28 to have only one stage that drives the plurality of stages of the HPC 24 without reducing an amount of work that the HPT 28 produces as compared to HPTs without the benefit of the present disclosure, while also reducing a weight of the HPT 28 and increasing an efficiency of the HPT 28, as compared to HPTs without the benefit of the present disclosure.

With less core air 64 (see FIG. 1) needed due to the added mass flow from the steam 176, the compression ratio of the HPC 24 may be increased as compared to HPCs without the benefit of the present disclosure. In this way, the HPC 24 has a compression ratio greater than 20:1. In some embodiments, the compression ratio of the HPC 24 is in a range of 20:1 to 40:1. Thus, the compression ratio of the HPC 24 is increased, thereby increasing the thermal efficiency of the turbine engine 10 as compared to HPCs and turbine engines without the benefit of the present disclosure. Further, the HPC 24 may have a reduced throat area due to the added mass flow in the core turbine engine 16 provided by the steam 176, 178 injected into the core turbine engine 16. Accordingly, the HPC 24 has a reduced size (e.g., outer diameter) and a reduced weight, as compared to turbine engines without the benefit of the present disclosure.

In some embodiments, the HPC stator vanes of at least two stages of the HPC 24 are variable stator vanes that are controlled to be pitched about a pitch axis to vary a pitch of the HPC stator vanes. In some embodiments, the HPC 24 includes one or more compressor bleed valves that are controlled to be opened to bleed a portion of the compressed air 65 (see FIG. 1) from the HPC 24. The one or more compressor bleed valves are preferably positioned between a fourth stage of the HPC 24 and a last stage of the HPC 24. The HPC stator vanes that are variable stator vanes, and the one or more compressor bleed valves help to balance the air flow (e.g., the compressed air 65) through all stages of the HPC 24. Such a balance, in combination with the steam 178 injected into the core air flow path 33, enables the number of stages of the HPC 24 to include ten to twelve stages for compression ratios to be greater than 20:1, and preferably in a range of 20:1 to 40:1.

The additional work that is extracted by the steam system 100 and the steam 178 injected into the core air flow path 33 enables a size of the core turbine engine 16 (FIG. 1) to be reduced, thereby increasing the bypass ratio of the turbine engine 10, as compared to turbine engines without the benefit of the present disclosure. In this way, the turbine engine 10 has a bypass ratio greater than 18:1, preferably, in a range of 18:1 to 100:1, more preferably, in a range of 25:1 to 85:1, and, most preferably, in a range of 28:1 to 70:1. In this way, the steam system 100 can enable an increased bypass ratio in which the turbine engine 10 can move a larger mass of air through the bypass, reducing the pressure ratio of the fan 38 and increasing the efficiency of the turbine engine 10 as compared to turbine engines without the benefit of the present disclosure.

The turbine engine 10 may also include an engine controller 120. The engine controller 120 is configured to operate various aspects of the turbine engine 10, including, in this embodiment, a first steam control valve 112, a second steam control valve 114, and the water pump 108. The engine controller 120 may be a Full Authority Digital Engine Control (FADEC). In this embodiment, the engine controller 120 is a computing device having one or more processors 122 and one or more memories 124. The processor 122 can be any suitable processing device, including, but not limited to, a microprocessor, a microcontroller, an integrated circuit, a logic device, a programmable logic controller (PLC), an application-specific integrated circuit (ASIC), and/or a Field Programmable Gate Array (FPGA). The memory 124 can include one or more computer-readable media, including, but not limited to, non-transitory computer-readable media, a computer-readable non-volatile medium (e.g., a flash memory), a RAM, a ROM, hard drives, flash drives, and/or other memory devices.

The memory 124 can store information accessible by the processor 122, including computer-readable instructions that can be executed by the processor 122. The instructions can be any set of instructions or a sequence of instructions that, when executed by the processor 122, causes the processor 122 and the engine controller 120 to perform operations. In some embodiments, the instructions can be executed by the processor 122 to cause the processor 122 to complete any of the operations and functions for which the engine controller 120 is configured, as will be described further below. The instructions can be software written in any suitable programming language, or can be implemented in hardware. Additionally, and/or alternatively, the instructions can be executed in logically and/or virtually separate threads on the processor 122. The memory 124 can further store data that can be accessed by the processor 122.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between components and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

As noted above, the first steam system 100a includes a water pump 108 that is positioned to increase the flow of the water 174 flowing into the boiler 102, resulting in an increase in pressure of the water 174. The water pump 108 similarly provides for an increase in pressure of the steam 176 flowing into the steam turbine 110 and pressure of the steam 178 flowing into the combustor 26. The turbine engine 10 does not operate in a steady operating condition. Instead, the turbine engine 10 is operated in various different operating conditions. For example, during a normal operating cycle for an aircraft, the turbine engine 10 may operate at high power for takeoff and climb (a high-power operation or condition) and at a low power (e.g., idle) for descent (a low-power operation or condition). High power and low power are taken relative to each other in this context. During flight, the turbine engine 10 may also be operated at cruise, which includes power conditions (operation) between the high-power condition and the low-power condition discussed above. At the different operating conditions, the amount of steam that is injected into the combustor 26 may be adjusted to have, for example, less steam for low-power operation and more steam for high-power operation. The first steam system 100a shown in FIG. 2 includes one or more flow control valves positioned between the boiler 102 and the combustor 26 to control the amount of steam flowing into the combustor 26.

In this embodiment, a first steam control valve 112 is positioned in the flow path (e.g., line) between the boiler 102 and the steam turbine 110, and a second steam control valve 114 is positioned in the flow path (e.g., line) between the steam turbine 110 and the combustor 26. The first steam control valve 112 is thus positioned upstream of the steam turbine 110 and downstream of the boiler 102 to control the flow of the steam 176 into the steam turbine 110. Similarly, the second steam control valve 114 is positioned upstream of the combustor 26 and downstream of the steam turbine 110 to control the flow of the steam 178 into the combustor 26. Any suitable flow control valve may be used as the first steam control valve 112 or the second steam control valve 114. Such flow control valves may have a closed position and a plurality of open positions including a fully open position. The flow control valves may be electrically operable valves, hydraulically operable valves, or pneumatically operable valves. When the flow control valves are hydraulically operable, the hydraulic fluid may be suitable fluids of the turbine engine 10 including, for example, the fuel 67, lubrication oil, and the like.

Various suitable water pumps may be used as the water pump 108 including variable speed water pumps. The water pump 108 may be, for example, a centrifugal pump. When the water pump 108 is a centrifugal pump, the flow rate of the steam 178 entering the combustor 26 is a function of combustor pressure and the injector (e.g., nozzle) injecting the steam 178 into the combustor 26. The engine controller 120 may be communicatively and operatively coupled to the second steam control valve 114 to change the position (i.e., to move) the second steam control valve 114 between the plurality of open positions and to control the overall flow rate of the steam 178 entering the combustor 26. When the water pump 108 is a centrifugal pump, the first steam control valve 112 may be used to control the differential pressure (pressure drop) across the steam turbine 110 and the rotational speed and other operating conditions of the steam turbine 110 may be controlled directly. This arrangement of the first steam control valve 112 and the second steam control valve 114 with the water pump 108 being a centrifugal pump may thus allow the pressure drop across the steam turbine 110 to be controlled somewhat independent from the flow rate of the steam 178 into the combustor 26.

Alternatively, the water pump 108 may be a positive-displacement pump. When the water pump 108 is a positive-displacement pump, the speed of the water pump 108 and the displacement of the water pump 108 controls the flow of the steam 176 into the steam turbine 110 and the combustor 26. In this case, the first steam control valve 112 and/or the second steam control valve 114 may be used to control the differential pressure (pressure drop) across the steam turbine 110.

As noted above, the engine controller 120 is communicatively and operatively coupled to the first steam control valve 112 and the second steam control valve 114. The engine controller 120 may also be communicatively and operatively coupled to the water pump 108 to control the speed and/or displacement of the water pump 108. The engine controller 120 may thus control the position of the first steam control valve 112 and the second steam control valve 114 in response to an input received by the engine controller 120 indicating a change in the operating condition of the turbine engine 10. For example, the engine controller 120 may receive an input indicating a change in the throttle position or other input indicating a change in the amount of fuel 67 being provided to the combustor 26, and the engine controller 120 may change the position of the first steam control valve 112 and/or the second steam control valve 114 in response to this input. The engine controller 120 may also be coupled to sensors positioned within the turbine engine 10 and or on the aircraft. Such sensors may include, for example, temperature sensors 126 and/or pressure sensors 128 positioned within the core air flow path 33 (e.g., the hot gas path 78). The temperature sensors 126 and the pressure sensors 128 are communicatively coupled to the engine controller 120. The engine controller 120 is configured to receive and to input from one of the temperature sensors 126 indicating a temperature of the turbine engine 10, and the engine controller 120 is configured to receive an input from one of the pressure sensors 128 indicating a pressure of the turbine engine 10. The input received from the temperature sensors 126 and/or the pressure sensors 128 may be the input indicating a change in the operating condition of the turbine engine 10. The engine controller 120 may also, similarly, control the speed of the water pump 108.

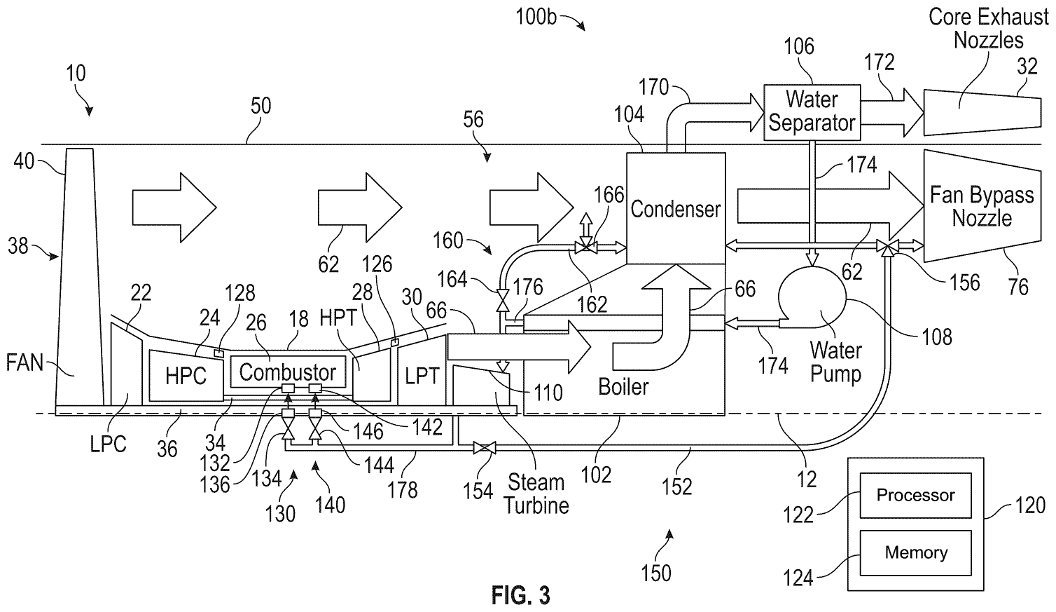

FIG. 3 is a schematic diagram of the turbine engine 10 having a steam system 100b according to another embodiment of the present disclosure. For clarity with the other steam systems discussed herein, the steam system 100b of this embodiment will be referred to as a second steam system 100b. The second steam system 100b may be used as the steam system 100 in the turbine engine 10 shown in FIG. 1. The second steam system 100b is similar to the first steam system 100a discussed above with reference to FIG. 2. The same reference numerals will be used for components of the second steam system 100b that are the same as or similar to the components of the first steam system 100a discussed above. The description of these components above also applies to this embodiment, and a detailed description of these components is omitted here.

The steam 178 may be injected into the combustor 26 using a plurality of steam injectors. Various suitable steam injectors may be used including, for example, nozzles and orifices formed in various components and fluidly coupled to the steam line delivering steam 178 from the steam turbine 110. In this embodiment, the combustor 26 includes a plurality of metering zones, including a first metering zone 130 and a second metering zone 140, that enable the flow of the steam 178 to be managed individually from each other. The second steam system 100b thus includes two or more sets of steam injectors including a first set of steam injectors 132 and a second set of steam injectors 142. In this embodiment, each metering zone includes a flow control valve operable to control the flow of the steam 178 into the corresponding zone. More specifically, the first metering zone 130 includes a third steam control valve 134, and the second metering zone 140 includes a fourth steam control valve 144. Any suitable flow control valve may be used for the third steam control valve 134 and the fourth steam control valve 144. The discussion above of suitable flow control valves for the first steam control valve 112 and the second steam control valve 114 also applies to the third steam control valve 134 and the fourth steam control valve 144.

The third steam control valve 134 is positioned downstream of the steam turbine 110 and upstream of a first steam manifold 136. The first steam manifold 136 is configured to distribute steam 178 to the first set of steam injectors 132. The third steam control valve 134 is thus positioned to control the flow of the steam 178 into the first metering zone 130 and, more specifically, the first set of steam injectors 132. The fourth steam control valve 144 is positioned downstream of the steam turbine 110 and upstream of a second steam manifold 146. The second steam manifold 146 is configured to distribute steam 178 to the second set of steam injectors 142. The fourth steam control valve 144 is thus positioned to control the flow of the steam 178 into the second metering zone 140 and, more specifically, the second set of steam injectors 142. The engine controller 120 may be communicatively and operatively coupled to each of the third steam control valve 134 and the fourth steam control valve 144 to control the third steam control valve 134 and the fourth steam control valve 144 in a manner similar to the operation of the first steam control valve 112 and the second steam control valve 114 discussed above.

In some embodiments, the steam 178 may be injected into the combustor 26 in combination with the fuel 67 (FIG. 1). The first set of steam injectors 132 may be part of fuel nozzle for injecting the fuel 67 into the combustor 26, and the first set of steam injectors 132 may be a combined steam/fuel injector. The combined steam/fuel injector may be preferred when the fuel 67 is a hydrogen fuel to minimize hot spots in the combustor 26 and to control the hydrogen flame. During transient operating conditions, however, the flow of steam 178 to the combined fuel/steam injector is preferably reduced, and the third steam control valve 134 may be operated to reduce the flow of steam 178 to the first set of steam injectors 132 under transient operating conditions.

The second steam system 100b may also include one or more bypass flow paths. Under some operational conditions, adding steam 178 to the combustor 26 may not be desirable. The second steam system 100b may thus include a bypass flow path that is selectively operable to redirect at least one of the steam 176, 178 or the water 174, and to bypass at least the combustor 26. As shown in FIG. 3, for example, the second steam system 100b includes a first steam bypass flow path 150 to bypass the combustor 26. The first steam bypass flow path 150 includes a first steam bypass line 152 fluidly connected to the steam line for the steam 178 downstream of the steam turbine 110 and upstream of the combustor 26. The first steam bypass flow path 150 includes a first steam bypass valve 154 located in the first steam bypass line 152. The first steam bypass valve 154 is operable to open and to direct the steam 178 through the first steam bypass line 152, bypassing the combustor 26, and, thus, the first steam bypass valve 154 selectively operates the first steam bypass valve 154 to bypass the combustor 26. The first steam bypass valve 154 may be any suitable valve including an isolation valve movable between an open position and a closed position.

The first steam bypass line 152 may be fluidly connected to various locations within the second steam system 100b to bypass the combustor 26. For example, the first steam bypass line 152 may be fluidly connected to the condenser 104 or to a position upstream of the condenser 104 allowing the steam 178 to flow and to mix with the combustion gases 66. The steam 178 flowing through the first steam bypass line 152 may thus be recaptured by the condenser 104 and circulated through the second steam system 100b. Bypassing the steam 178 into the condenser 104, instead of the exhaust nozzle (e.g., the fan bypass nozzle 76), minimizes contrail formation. Instead of being recaptured, the steam 178 may be exhausted overboard, such as by being fluidly connected to an exhaust port. The exhaust port may be fluidly connected to the bypass airflow passage 56 or the fan bypass nozzle 76. In this way, the steam 178 may be exhausted into the bypass air 62, such as, for example, either upstream of the condenser 104 or downstream of the condenser 104. In some embodiments, the steam 178 may be selectively exhausted or recaptured. A first selector valve 156 may be positioned in the first steam bypass line 152 to fluidly couple first steam bypass line 152 to the outlets discussed above. Any suitable first selector valve 156 may be used, including a three-way valve.

In addition to bypassing the combustor 26, the second steam system 100b may include a second steam bypass flow path 160 to bypass the steam turbine 110 and the combustor 26. Similar to the first steam bypass flow path 150, the second steam bypass flow path 160 includes a second steam bypass line 162 fluidly coupled to the steam line for the steam 176 at a position upstream of the steam turbine 110 and downstream of the boiler 102. The second steam bypass line 162 may be fluidly connected to the same positions of the second steam system 100b to selectively discharge the steam 176, as the first steam bypass line 152 discussed above. The second steam bypass flow path 160 may be selectively operable using valves such as a second steam bypass valve 164 and a second selector valve 166. The second steam bypass valve 164 may be operable in a manner similar to the first steam bypass valve 154, and the second selector valve 166 operable in a manner similar to the first selector valve 156. The discussion of those valves applies here.

In some embodiments, the first steam bypass valve 154 and the second steam bypass valve 164 may be flow control valves, allowing a portion of the steam 178 from the steam turbine 110 and/or the steam 176 from the boiler 102 to bypass the downstream components. The first steam bypass flow path 150 and the second steam bypass flow path 160 may be used in a drying cycle to remove water from the second steam system 100b. These steam bypass flow paths may also be used for various other operational transient conditions, such as, for example, flameout/engine re-light, deceleration, and rain or ice ingestion. The engine controller 120 may be communicatively and operatively coupled to each of the valves of the bypass flow paths to operate these valves in response to an input indicating one of these operational conditions has occurred. The discussion of the control of the flow control valves may also apply to the control of the bypass valves and the selector valves discussed herein.

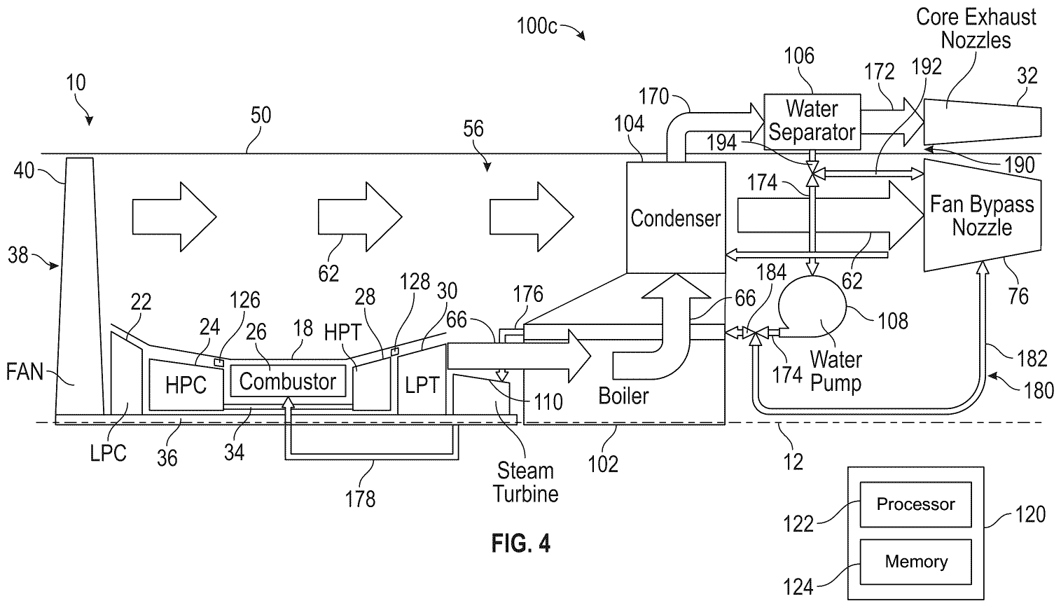

FIG. 4 is a schematic diagram of the turbine engine 10 having a steam system 100c according to another embodiment of the present disclosure. For clarity with the other steam systems discussed herein, the steam system 100c of this embodiment will be referred to as a third steam system 100c. The third steam system 100c may be used as the steam system 100 in the turbine engine 10 shown in FIG. 1. The third steam system 100c is similar to the first steam system 100a discussed above with reference to FIG. 2 and the second steam system 100b discussed above with reference to FIG. 3. The same reference numerals will be used for components of the third steam system 100c that are the same as or similar to the components of first steam system 100a and/or the second steam system 100b discussed above. The description of these components above also applies to this embodiment, and a detailed description of these components is omitted here.

In the second steam system 100b, the bypass flow paths include bypass paths for the steam 176, 178. The third steam system 100c of this embodiment includes one or more bypass flow paths for the water 174. Each of the water bypass flow paths is fluidly connected to the water 174 upstream of the boiler 102 and downstream of the water separator 106. A first water bypass line 182 of a first water bypass flow path 180 is fluidly connected to the line connecting the water pump 108 to the boiler 102, and, thus, the first water bypass line 182 is fluidly connected downstream of the water pump 108. A first water bypass valve 184 is positioned in the first water bypass line 182 to open and to close the first water bypass line 182. The first water bypass line 182 may be connected to the fan bypass nozzle 76 or another drain (e.g., a drain port) to discharge the water 174 when the first water bypass valve 184 is positioned to open the first water bypass line 182.

Similarly, a second water bypass line 192 of a second water bypass flow path 190 is fluidly connected to the line connecting the water separator 106 to the water pump 108, and the second water bypass line 192 is fluidly connected upstream of the water pump 108. A second water bypass valve 194 is positioned in the second water bypass line 192 to open and to close the second water bypass line 192. The second water bypass line 192 may be connected to the fan bypass nozzle 76 or another drain (e.g., a drain port) to discharge the water 174 when the second water bypass valve 194 is positioned to open the second water bypass line 192.

The engine controller 120 may be communicatively and operatively coupled each of the valves of the bypass flow paths to operate these valves.

The foregoing discussion includes various different components in different embodiments of the steam system 100. The components and features of the first steam system 100a, the second steam system 100b, and the third steam system 100c are not mutually exclusive and one or more of the components shown and described in one of the first steam system 100a, the second steam system 100b, or the third steam system 100c may be applied to another one the first steam system 100a, the second steam system 100b, or the third steam system 100c.

The steam systems 100 discussed herein include multiple different flow paths and flow control valves that allow the steam system 100 to be adjusted based on the operational condition of the turbine engine 10. The flow control valves may be used to control the flow of steam 178 into the combustor 26 (including to various zones within the combustor 26) and/or the flow of steam 176 across the steam turbine 110. In addition, the bypass flow paths may be used to divert the steam and/or water when steam 178 is not needed in the combustor 26. Such bypass flow paths may be used for operations to drain and/or to dry out the turbine engine 10.

Further aspects of the present disclosure are provided by the subject matter of the following clauses.

A turbine engine for an aircraft. The turbine engine includes a core turbine engine, a fan having a fan shaft coupled to the core turbine engine to rotate the fan shaft, and a steam system. The core turbine engine includes a core air flow path for core air to flow therethrough, a combustor, a core shaft, and a turbine. The combustor is located in the core air flow path to receive compressed air and fluidly coupled to a fuel source to receive fuel. The fuel is injected into the combustor to mix with the compressed air to generate a fuel and air mixture, and the fuel and air mixture being combusted in the combustor to generate combustion gases. The a turbine is located downstream of the combustor to receive the combustion gases and to cause the turbine to rotate, the turbine coupled to the core shaft to rotate the core shaft when the turbine rotates. The steam system fluidly coupled to the core air flow path to selectively provide steam to the core air flow path to add mass flow to the core air. The steam system includes a boiler and a steam turbine. The boiler is located downstream of the combustor. The boiler receives water and is fluidly connected to the combustor to receive the combustion gases and to boil the water to generate the steam. The steam turbine is fluidly coupled to the boiler to receive the steam from the boiler and to cause the steam turbine to rotate. The steam turbine being coupled to the core shaft to rotate the core shaft when the steam turbine rotates.

The turbine engine of the preceding clause, wherein steam system selectively provides steam to the core air flow path.

The turbine engine of any preceding clause, further comprising at least one steam control valve located downstream of the boiler and upstream of the core air flow path to control the flow of the steam.

The turbine engine of the preceding clause, wherein the at least one steam control valve is located upstream of the steam turbine.

The turbine engine of any preceding clause, wherein the at least one steam control valve is located downstream of the steam turbine.

The turbine engine of any preceding clause, wherein the at least one steam control valve is one of a plurality of steam control valves, the plurality of steam control valves including a first steam control valve and a second steam control valve.

The turbine engine of any preceding clause, wherein the first steam control valve is located upstream of the steam turbine, and the second steam control valve is located downstream of the steam turbine.

The turbine engine of any preceding clause, wherein the steam system injects the steam into the combustor.

The turbine engine of the preceding clause, wherein the combustor includes a plurality of metering zones for injecting steam into the combustor, the plurality of metering zones including a first metering zone and a second metering zone, the first steam control valve located to control the flow of steam to the first metering zone, and the second steam control valve located to control the flow of steam to the second metering zone.

The turbine engine of any preceding clause, wherein the first metering zone includes a first set of steam injectors, and the second metering zone includes a second set of steam injectors.

The turbine engine of any preceding clause, wherein the first metering zone includes a first steam manifold configured to distribute steam to the first set of steam injectors, and the second metering zone includes a second steam manifold configured to distribute steam to the second set of steam injectors.

The turbine engine of any preceding clause, wherein the first steam control valve is located upstream of the first steam manifold, and the second steam control valve is located upstream of the second steam manifold.

The turbine engine of any preceding clause, further comprising a controller operatively coupled to the at least one steam control valve to change the position of the at least one steam control valve.

The turbine engine of any preceding clause, wherein the at least one steam control valve includes a plurality of open positions, the controller being configured to move the at least one steam control valve among the plurality of open positions.

The turbine engine of any preceding clause, further comprising a water pump in fluid communication with the boiler to direct the flow of water into the boiler, the controller operatively coupled to the water pump to control the speed of the water pump.

The turbine engine of any preceding clause, wherein the controller is configured to change the speed of the water pump in response to an input received by the controller indicating a change in an operating condition of the turbine engine.

The turbine engine of any preceding clause, wherein the controller is configured to change the position of the at least one steam control valve in response to an input received by the controller indicating a change in an operating condition of the turbine engine.

The turbine engine of any preceding clause, wherein the controller is communicatively coupled to a sensor that sends the input indicating the change in the operating condition of the turbine engine to the controller.

The turbine engine of any preceding clause, further comprising the sensor.

The turbine engine of any preceding clause, wherein the sensor is located in the core air flow path.

The turbine engine of any preceding clause, wherein the sensor is a temperature sensor and the input indicating the change in the operating condition of the turbine engine is a temperature detected by the temperature sensor.

The turbine engine of any preceding clause, wherein the sensor is a pressure sensor and the input indicating the change in the operating condition of the turbine engine is a pressure detected by the pressure sensor.

The turbine engine of any preceding clause, further comprising a water pump in fluid communication with the boiler to direct the flow of water into the boiler, the water pump being one of a centrifugal pump or a positive displacement pump.

The turbine engine of any preceding clause, further comprising a bypass flow path selectively operable to redirect at least one of the steam or the water, and to bypass the core air flow path.

The turbine engine of the preceding clause, wherein the steam system includes the bypass flow path.

The turbine engine of any preceding clause, wherein the bypass flow path is a steam bypass flow path that is fluidly connected to the steam system at a location downstream of the boiler and upstream of the core air flow path.

The turbine engine of any preceding clause, wherein the bypass flow path is a steam bypass flow path that is fluidly connected to the steam system at a location downstream of the boiler and upstream of the combustor.

The turbine engine of any preceding clause, wherein the steam bypass flow path is fluidly connected to the steam system at a location downstream of the steam turbine.

The turbine engine of any preceding clause, wherein the steam bypass flow path is fluidly connected to the steam system at a location upstream of the steam turbine.

The turbine engine of any preceding clause, wherein the steam bypass flow path is fluidly connected to an exhaust port to selectively exhaust the steam.

The turbine engine of any preceding clause, further comprising a condenser located downstream of the boiler to condense water from the combustion gases and to generate an exhaust-water mixture, the steam bypass flow path fluidly connected to the condenser to selectively direct the flow of steam into the condenser.

The turbine engine of any preceding clause, wherein the steam bypass flow path is fluidly connected to an exhaust port to selectively exhaust the steam.

The turbine engine of any preceding clause, wherein the bypass flow path is operable to selectively redirect the steam to at least one of the condenser or the exhaust port.

The turbine engine of any preceding clause, wherein the steam bypass flow path includes a valve operable to selectively redirect the steam to at least one of the condenser or the exhaust port.

The turbine engine of any preceding clause, further comprising a bypass airflow passage for bypass air, the water bypass flow path fluidly connected to the bypass airflow passage to selectively direct the flow of steam into the bypass airflow passage.

The turbine engine of any preceding clause, wherein the bypass airflow passage includes a bypass airflow exhaust nozzle for exhausting the bypass air, the steam bypass flow path fluidly connected to the bypass airflow exhaust nozzle.

The turbine engine of any preceding clause, further comprising a condenser located downstream of the boiler to condense water from the combustion gases and to generate an exhaust-water mixture, the condenser located in the bypass airflow passage for bypass air to cool the combustion gases and to condense the water from the combustion gases, generating a cooled exhaust.

The turbine engine of any preceding clause, wherein the steam bypass flow path is fluidly connected to the bypass airflow passage at a position downstream of the condenser.

The turbine engine of any preceding clause, wherein the steam bypass flow path is fluidly connected to the bypass airflow passage at a position upstream of the condenser.

The turbine engine of any preceding clause, wherein the core shaft is a low-pressure shaft and the turbine is a low-pressure turbine.

The turbine engine of any preceding clause, wherein the fan shaft coupled to the low-pressure shaft to be driven by the low-pressure shaft.

The turbine engine of any preceding clause, wherein fan includes a plurality of blades.

The turbine engine of any preceding clause, wherein first portion of air flowing into the fan flows through the bypass airflow passage as the bypass air and a second portion of the air flowing into the fan flows through the core air flow path as core air.

The turbine engine of any preceding clause, wherein the bypass flow path is a water bypass flow path that is fluidly connected to the steam system at a location upstream of the boiler to selectively redirect the water and to bypass the boiler.

The turbine engine of any preceding clause, wherein the water bypass flow path is fluidly connected to a drain port to selectively discharge the water.

The turbine engine of any preceding clause, further comprising a bypass airflow passage for bypass air, the water bypass flow path fluidly connected to the bypass airflow passage to selectively direct the flow of water into the bypass airflow passage.

The turbine engine of any preceding clause, wherein the bypass airflow passage includes a bypass airflow exhaust nozzle for exhausting the bypass air, the water bypass flow path fluidly connected to the bypass airflow exhaust nozzle.

The turbine engine of any preceding clause, further comprising a water pump in fluid communication with the boiler to direct the flow of water into the boiler, the water bypass flow path fluidly connected to the steam system at a location downstream of the water pump.

The turbine engine of any preceding clause, further comprising a condenser located downstream of the boiler to condense water from the combustion gases and to generate an exhaust-water mixture.

The turbine engine of any preceding clause, further comprising a water separator located downstream of the condenser, the water separator separating the water from the exhaust-water mixture and the water separator fluidly connected to the boiler to provide the water to the boiler, wherein the water bypass flow path is fluidly connected to the steam system at a location downstream of the water separator.

The turbine engine of any preceding clause, wherein the water separator is a cyclonic separator.

The turbine engine of any preceding clause, further comprising a water pump in fluid communication with the water separator and with the boiler to direct the flow of water from the water separator into the boiler.

The turbine engine of any preceding clause, wherein the water bypass flow path is fluidly connected to the steam system at a location downstream of the water pump.

The turbine engine of any preceding clause, wherein the water bypass flow path is fluidly connected to the steam system at a location upstream of the water pump.

The turbine engine of any preceding clause, wherein the bypass flow path includes at least one bypass valve operable to selectively redirect the at least one of the steam or the water, and to bypass the core air flow path.

The turbine engine of any preceding clause, wherein the bypass flow path includes at least one bypass valve operable to selectively redirect the at least one of the steam or the water, and to bypass the combustor.

The turbine engine of any preceding clause, further comprising a controller, the controller operatively coupled to the at least one bypass valve to change the position of the at least one bypass valve and to selectively redirect the at least one of the steam or the water and to bypass the core air flow path.

The turbine engine of any preceding clause, further comprising a controller, the controller operatively coupled to the at least one bypass valve to change the position of the at least one bypass valve and to selectively redirect the at least one of the steam or the water and to bypass the combustor.

The turbine engine of any preceding clause, wherein the controller is configured to change the position of the at least one bypass valve in response to an input received by the controller indicating a change in an operating condition of the turbine engine.

The turbine engine of any preceding clause, wherein the controller is communicatively coupled to a sensor that sends the input indicating the change in the operating condition of the turbine engine to the controller.

The turbine engine of the preceding clause, further comprising the sensor.

The turbine engine of any preceding clause, wherein the sensor is located in the core air flow path.

The turbine engine of any preceding clause, wherein the sensor is a temperature sensor and the input indicating the change in the operating condition of the turbine engine is a temperature detected by the temperature sensor.

The turbine engine of any preceding clause, wherein the sensor is a pressure sensor and the input indicating the change in the operating condition of the turbine engine is a pressure detected by the pressure sensor.

The turbine engine of any preceding clause, wherein the core shaft is a low-pressure shaft and the turbine is a low-pressure turbine.

The turbine engine of any the preceding clause, further comprising a low-pressure compressor connected to the low-pressure shaft to be driven by the low-pressure turbine and the steam turbine.

The turbine engine of any the preceding clause, further comprising a bypass airflow passage and a condenser. A first portion of air flowing into the fan flowing through the bypass airflow passage as bypass air and a second portion of the air flowing into the fan flowing through the core air flow path as core air. The condenser is positioned downstream of the boiler and in the bypass airflow passage for bypass air to cool the combustion gases and to condense the water from the combustion gases.

The turbine engine of any the preceding clause, further comprising a low-pressure compressor positioned in the core air flow path upstream of the compressor, the low-pressure compressor being driven by the low-pressure shaft to compress the core air flowing through the core air flow path and to generate the compressed air.

The turbine engine of any the preceding clause, further comprising a high-pressure shaft, a high-pressure turbine, and a high-pressure compressor. The high-pressure turbine is positioned downstream of the combustor to receive the combustion gases and to cause the high-pressure turbine to rotate. The high-pressure turbine is coupled to the high-pressure shaft to rotate the high-pressure shaft when the high-pressure turbine rotates. The high-pressure compressor is positioned in the core air flow path upstream of the combustor and downstream of the low-pressure compressor. The high-pressure compressor is driven by the high-pressure shaft to compress the core air flowing through the core air flow path and to generate the compressed air.

The turbine engine of any the preceding clause, further comprising a condenser positioned downstream of the boiler to condense water from the combustion gases and to generate an exhaust-water mixture.

The turbine engine of any the preceding clause, further comprising a bypass airflow passage for bypass air, the condenser positioned in the bypass airflow passage for bypass air to cool the combustion gases and to condense the water from the combustion gases, generating a cooled exhaust.

The turbine engine of any the preceding clause, further comprising a water separator positioned downstream of the condenser, the water separator separating the water from the cooled exhaust.

The turbine engine of any the preceding clause, wherein the water separator is a cyclonic separator.

The turbine engine of any the preceding clause, wherein the boiler is fluidly coupled to the water separator.

The turbine engine of any the preceding clause, further comprising a water pump in fluid communication with the water separator and with the boiler to direct the flow of water from the water separator into the boiler.

The turbine engine of any preceding clause, wherein the steam system extracts water from the combustion gases and vaporizes the water to generate steam using the boiler.

The turbine engine of the preceding clause, wherein the fan is coupled to the core shaft such that rotation of the turbine causes the fan to rotate.

The turbine engine of the preceding clause, further comprising a nacelle. The nacelle circumferentially surrounds the fan.

The turbine engine of the preceding clause, wherein the nacelle defines a bypass airflow passage between the nacelle and the core turbine engine.

The turbine engine of the preceding clause, wherein the fan includes a plurality of fan blades that rotates to generate a volume of air. The volume of air from the fan is split and flows into the bypass airflow passage as bypass air and flows into the core air flow path as the core air.

The turbine engine of the preceding clause, wherein a bypass ratio of the bypass air to the core air is greater than 18:1.

The turbine engine of any preceding clause, wherein the bypass ratio is in a range of 18:1 to 100:1.

The turbine engine of any preceding clause, wherein the bypass ratio is in a range of 25:1 to 85:1.

The turbine engine of any preceding clause, wherein the bypass ratio is in a range of 28:1 to 70:1.

The turbine engine of any preceding clause, wherein the core turbine engine further includes a compressor that compresses the core air to generate the compressed air. The compressor is coupled to the core shaft and defines a portion of the core air flow path.

The turbine engine of the preceding clause, wherein the compressor includes a high-pressure compressor and includes a compression ratio greater than 20:1.

The turbine engine of the preceding clause, wherein the plurality of stages of the compressor includes ten to twelve stages.

The turbine engine of any preceding clause, wherein the turbine includes a high-pressure turbine (HPT) and includes only one stage of HPT rotor blades and HPT stator vanes.

The turbine engine of any preceding clause, further comprising a low-pressure turbine.

The turbine engine of the preceding clause, wherein the low-pressure turbine has a low-pressure shaft coupled to the fan shaft.

The turbine engine of any preceding clause, further comprising a low-pressure compressor coupled to the low-pressure shaft to be driven by the low-pressure turbine and the steam turbine.

The turbine engine of any preceding clause, the low-pressure turbine having a pressure expansion ratio in a range of 4.5:1 to 28:1.

The turbine engine of any preceding clause, the high-pressure turbine having a pressure expansion ratio in a range of 1.5:1 to 4:1.

Although the foregoing description is directed to the preferred embodiments of the present disclosure, other variations and modifications will be apparent to those skilled in the art and may be made without departing from the spirit or the scope of the disclosure. Moreover, features described in connection with one embodiment of the present disclosure may be used in conjunction with other embodiments, even if not explicitly stated above.

1. A turbine engine for an aircraft, the turbine engine comprising:
a core turbine engine including:
a core air flow path for core air to flow therethrough;
a combustor located in the core air flow path to receive compressed air and fluidly coupled to a fuel source to receive fuel, the fuel being injected into the combustor to mix with the compressed air to generate a fuel and air mixture, the fuel and air mixture being combusted in the combustor to generate combustion gases;
a core shaft; and
a turbine located downstream of the combustor to receive the combustion gases and to cause the turbine to rotate, the turbine coupled to the core shaft to rotate the core shaft when the turbine rotates;
a fan having a fan shaft coupled to the core turbine engine to rotate the fan shaft; and
a steam system fluidly coupled to the core air flow path to provide steam to the core air flow path to add mass flow to the core air, the steam system including:
a boiler located downstream of the combustor, the boiler receiving water and being fluidly connected to the combustor to receive the combustion gases and to boil the water to generate the steam;
a steam turbine fluidly coupled to the boiler to receive the steam from the boiler and to cause the steam turbine to rotate, the steam turbine being coupled to the core shaft to rotate the core shaft when the steam turbine rotates; and
at least one steam control valve located downstream of the boiler and upstream of the core air flow path to control a differential pressure across the steam turbine.

2. The turbine engine of claim 1, wherein the at least one steam control valve is located upstream of the steam turbine.

3. The turbine engine of claim 1, wherein the at least one steam control valve is located downstream of the steam turbine.

4. The turbine engine of claim 1, wherein the at least one steam control valve is one of a plurality of steam control valves, the plurality of steam control valves including a first steam control valve and a second steam control valve, the first steam control valve located upstream of the steam turbine, and the second steam control valve located downstream of the steam turbine.

5. The turbine engine of claim 1, wherein the steam system is fluidly coupled to the combustor to inject the steam into the combustor,
wherein the at least one steam control valve is one of a plurality of steam control valves, the plurality of steam control valves including a first steam control valve and a second steam control valve, and
wherein the combustor includes a plurality of metering zones for injecting steam into the combustor, the plurality of metering zones including a first metering zone and a second metering zone, the first steam control valve located to control the flow of steam to the first metering zone, and the second steam control valve located to control the flow of steam to the second metering zone.

6. The turbine engine of claim 1, further comprising a controller operatively coupled to the at least one steam control valve to change a position of the at least one steam control valve in response to an input received by the controller indicating a change in an operating condition of the turbine engine.

7. The turbine engine of claim 6, further comprising a sensor, the controller communicatively coupled to the sensor that sends the input indicating the change in the operating condition of the turbine engine to the controller.

8-20. (canceled)

21. The turbine engine of claim 4, wherein the first steam control valve is located upstream of the steam turbine and downstream of the boiler.

22. The turbine engine of claim 4, wherein the second steam control valve is located upstream of the combustor and downstream of the steam turbine.

23. The turbine engine of claim 4, wherein the first steam control valve controls the differential pressure across the steam turbine.

24. The turbine engine of claim 4, wherein the first steam control valve controls the differential pressure across the steam turbine, and the second steam control valve controls a flow rate of the steam into the combustor.

25. The turbine engine of claim 24, wherein the differential pressure across the turbine and the flow rate of the steam into the combustor are controlled independently of each other.
